(19) United States
(12) Patent Application Publication
(10) Pub. No.: US 2016/0138542 A1
(43) Pub. Date: May 19, 2016

(54) Fuel Injection Valve For A Combustion Engine

(71) Applicant: CONTINENTAL AUTOMOTIVE GMBH, Hannover (DE)

(72) Inventors: Francesco Lenzi, Livorno (IT); Mauro Grandi, Livorno (IT); Stefano Filippi, Castel' Anselmo Collesalvetti (IT)

(73) Assignee: Continental Automotive GmbH, Hannover (DE)

(21) Appl. No.: 14/904,280

(22) PCT Filed: May 21, 2014
(86) PCT No.: PCT/EP2014/060454

§ 371 Date: Jan. 11, 2016

(30) Foreign Application Priority Data
Jul. 10, 2013 (EP) 13175863.3

(51) Int. Cl. F02M 61/16

(52) U.S. Cl. CPC F02M 61/166

(57) ABSTRACT

A fuel injection valve for a combustion engine comprises a valve body with a valve cavity and a nozzle body. The nozzle body may limit a free volume of the valve cavity and comprises at least one nozzle aperture. The nozzle body may comprise a surface facing a combustion chamber of the combustion engine and at least partially surrounding the at least one nozzle aperture. The surface comprises a first area designed to form a wetting angle (θ) with a fluid, which is larger than 90°.

### TECHNICAL FIELD

The invention relates generally to combustion engines and more specifically to a fuel injection valve and a nozzle body for a combustion engine.

### BACKGROUND

Fuel injection valves are in widespread use, in particular for internal combustion engines, where they may be arranged in order to dose a fluid into an intake manifold of the internal combustion engine or directly into a combustion chamber of a cylinder of the internal combustion engine.

Due to increasingly strict legal regulations concerning the admissibility of pollutant emissions by internal combustion engines, which are arranged in vehicles for example, it is necessary to take actions in various ways in order to reduce these pollutant emissions.

One possible starting point is to reduce the pollutant emissions which are directly produced by the combustion engine. For example, the generation of soot is highly dependent on the fuel-mixture preparation in a respective cylinder of the combustion engine.

Performance degradation of the combustion process can occur during engine lifetime due to coking of the fuel injection valves.

### SUMMARY

One object of the disclosure is to describe a fuel injection valve for a combustion engine which facilitates a reliable and precise function.

According to some teachings of the present disclosure, some embodiments may include a nozzle body for a fuel injection valve. Some embodiments may include a fuel injection valve for a combustion engine.

The injection valve may comprise a valve body, wherein the valve body comprises a valve cavity and the nozzle body. The nozzle body may comprise a separate piece which is fixed to a valve base body, for example by a press-fit connection and/or a brazed or welded connection. In other embodiments, the nozzle body may be in one piece with the valve base body.

The valve cavity may extend from a fuel inlet end to a fuel outlet end of the valve body. The nozzle body may limit a free volume of the valve cavity. The nozzle body may be positioned at the fuel outlet end of the valve base body and/or the nozzle body may be arranged at a downstream end of the valve cavity.

The nozzle body may comprise at least one nozzle aperture. Further, the nozzle body comprises an outer surface facing a combustion chamber of the combustion engine and surrounding the at least one nozzle aperture. The nozzle aperture may extend through the nozzle body from an inner surface of the nozzle body to an outer surface of the nozzle body. The inner surface in particular faces towards the valve cavity. The outer surface is in particular on the side remote from the valve cavity. The inner surface may face towards the fuel inlet end and the outer surface may face away from the fuel inlet end of the injection valve.

The outer surface may comprise a first area designed to form a contact angle with a fluid, which is larger than 90°. The first area may-partially or completely-laterally surround the nozzle aperture. It may be laterally spaced from the nozzle aperture or it may directly adjoin the nozzle aperture.

In some embodiments, the fluid may be gasoline or diesel. If the contact angle is larger than 90°, the first area of the outer surface is a fluid-phobic surface, which may also be called fluid-phobic contact surface.

The contact angle may be defined as the angle between a surface and a liquid droplet of the fluid. The contact angle can also be called wetting angle and/or edge angle. The contact angle is, for example, defined by Young's equation. The smaller the contact angle, the stronger the effect of the droplet to be stuck to the surface. The larger the contact angle, the stronger the effect of the fluid-phobic surface to offload a droplet. For example, a very small contact angle is nearly 0° and thus a droplet can easily attach to the surface. In contrast thereto, a large contact angle, for example, is about 140° and thus, a droplet will rather detach from the surface. The contact angle depends on energy considerations of the interaction between the substances on the contact surface. The lower the interaction is, the larger the contact angle is, because it is energetically more favorable for a fluid to form a spherical droplet than to attach to the contact surface. Generally, if the contact angle is smaller than 90°, the surface is considered fluid-philic. If the contact angle is larger than 90°, the surface is considered fluid-phobic.

The teachings of the present disclose may provide a nozzle body and the fuel injection valve that make use of the idea that pollutant emissions can be reduced by essentially avoiding the formation of deposits on the outer surface of the nozzle body. The region of the nozzle body can also be called injector tip. Such deposits on the injector tip deteriorate the injection valve functions—in particular the spray characteristics of the fuel leaving the nozzle aperture—during engine application.

### BRIEF DESCRIPTION OF THE DRAWINGS

In the figures:

FIG. 1 shows an injection valve in a longitudinal section view,

FIG. 2 shows an enlarged section view of an injection tip, and

FIG. 3 shows a schematic sectional view of a surface of a nozzle body.

### DETAILED DESCRIPTION

Injector tip deposits are mainly generated by the so-called “tip-wetting” behaviour, wherein fuel droplets remain on the injector tip after an injection process. Fuel droplets on the injector tip are responsible for degradation of emission performances. During the injection process, the fluid—for example fuel like gasoline or diesel—may wet the surface of the injector tip. This may lead to the deposits which essentially consist of carbon and result from coking of the wet residues on the injector tip. Normally, these deposits have a porous structure, which favors the coking process during subsequent injection processes by absorbing gaseous and/or liquid fluid. This leads to a high carbon-(also HC-) and particle emission.

The outer surface of the nozzle body according to the present disclosure essentially avoids an aggregation or adhesion of droplets on the surface. Thus, coking of fluid respectively fluid droplets and formation of deposits during injection and combustion processes can be avoided and a reduced pollutant emission or particle emission is achieved.

The first area of the outer surface may exhibit a fluid contact angle, which is large enough to minimize the sticking force between the fluid and the outer surface of the nozzle body. For example, the fluid contact angle is larger than 90°, in particular for gasoline or diesel as the fluid. Liquid droplets, which may attach to the outer surface of the nozzle body during an injection process may easily detach from the outer surface. Thus, any accumulation of droplets, coking of them and/or deposits can be avoided completely or at least to a particularly large extent. In this way, a particularly small injector flow shift over lifetime is achievable. Further, a minimized variation of the fuel spray during injection and a minimized particle emission or pollutant emission is achievable.

Vibration of the engine and/or the movement of combustion gas or air in the cylinder during operation as an external stimulus may be sufficient to detach fuel droplets from the outer surface of the nozzle body according to the present disclosure. During times the engine is turned off, the droplets can possibly detach as soon as the engine is turned on again.

In various embodiments, the first area of the outer surface comprises small projections and/or large recesses. For example, the maximum lateral dimension of each of the projections is smaller than the distance between laterally adjacent projections. The distance is in particular the distance between the geometric centers of gravity of the projections.

The small projections and/or the large recesses can be produced by a laser scattering. For example, the small projections can be small bumps and/or pins which are in particular separated from each other by large recesses. Thus, in the first area, the outer surface can form a contact angle with a fluid, which is larger than 90°, in order for droplets to easily detach from the outer surface.

In various embodiments the projections in the first area can have lateral dimensions in nanometer range. The “nanometer range” in the present context is in particular understood to be the range from 1 nm to 100 nm, where the limits are included.

In various embodiments, the recesses in the first area can have lateral dimensions in micrometer range. In various embodiments, the distances between laterally adjacent protrusions may be in the micrometer range in the first area. The “micrometer range” in the present context is in particular understood to be the range from 100 nm to 100 μm. In some embodiments the dimensions may be in the range from 100 nm to 10 μm.

In various embodiments the maximum lateral dimension, e.g., the maximum diameter, of the projections is between 30 nm and 100 nm, inclusive, in the first area. A maximum diameter of the large recesses or the maximum distance between laterally adjacent protrusions in the first area may be between 300 nm and 600 nm in various embodiments.

In various embodiments, the outer surface additionally comprises a second area which is designed to form a contact angle with a fluid, which is smaller than 90°. The fluid is in particular the same fluid with which the first area forms a contact angle of more than 90°.

The second area may be adjacent to the first area, preferably it may adjoin the first area. For example, the first area is laterally surrounded by the second area.

The second area has a weaker fluidphobicity than the first area. Due to the before mentioned energy considerations, droplets of fluid naturally move towards areas which are only slightly fluid-phobic or at least less fluid-phobic than the surface they start moving from. Since the second area of the outer surface is adjacent to the first area of the outer surface, a droplet which is stuck to the first area, tries to move to the adjacent second area. By moving from the first area to the second area the droplet can drag along eventual coking deposits from former injection processes. This helps to avoid any accumulation of such coking deposits, in particular in the first area. Additionally, a moving droplet can more easily detach from the outer surface.

In various embodiments the second area of the outer surface comprises small recesses and/or large projections. For example, the maximum lateral dimension of each of the projections is larger than the distance between laterally adjacent projections.

In contrast to the first area described above, the second area comprises large projections, which can also be bumps and/or pins, for example. Small recesses may be separating the large projections. This helps to achieve, in the second area, a contact angle with a fluid—in particular with gasoline or diesel—which is smaller than 90° and thus supports the sticking of a droplet of the fluid to the second area of the outer surface.

Since droplets naturally tend to move towards areas of weak fluidphobicity as described above, a droplet may spontaneously move from the first area to the second area of the outer surface. The first area and the second area can also be called a bimodal roughness. As described above, the initial droplet motion may require an external stimulus that is given, for example, by the vibrations when the engine is started and/or also when air motion is produced within the combustion chamber. Again, during times the engine is turned off, the droplets also may spontaneously move towards areas of weaker fluidphobicity and may be detached as soon as the engine is turned on again.

In various embodiments, the recesses in the second area have lateral dimensions in nanometer range. In various embodiments, the distances between laterally adjacent protrusions may be in the nanometer range in the second area. In various embodiments, the projections in the second area have lateral dimensions in micrometer range.

In various embodiments, the maximum lateral dimension, e.g. the maximum diameter of the projections is between 300 nm and 600 nm, the limits being included, in the second area. In various embodiments, a maximum diameter of the recesses or the maximum distance between laterally adjacent protrusions in the second area is between 30 nm and 100 nm, the limits being included. Large projections and/or small recesses having such dimensions guarantee that the second area of the surface forms a contact angle with a fluid which is smaller than 90°.

In various embodiments, the first area of the outer surface is arranged closer to the at least one nozzle aperture than the second area of the outer surface. Thus, a droplet stuck to the surface, which tries to spontaneously move to the second area of the surface, moves away from the at least one nozzle aperture. Since droplets or deposits next or close to the nozzle aperture may interfere with the injection spray of the injection valve, it is desired that the droplets or deposits are not close to the nozzle aperture. Thus, a minimized variation of the spray angle and a minimized injection flow shift over lifetime is achievable with the nozzle body according to the present disclosure. For example, droplets or deposits next to the nozzle aperture can be seen as obstacles, which may influence the spray angle. Additionally, the penetration of the fluid spray may be negatively influenced.

In various embodiments the outer surface of the injection nozzle is at least partially covered by at least one coating, in particular a fluid-phobic coating forming a wetting angle with a fluid larger than 90°. Such a coating, which can be for example Teflon, can additionally be brought up to the outer surface, e.g. to the first area of the outer surface, in order to support the formation of a wetting angle with a fluid larger than 90°. With such a coating, for example, a modified surface favoring the forming of the desired contact angle can be achieved. Such a coating can have a very small thickness in the range of 10 nm to 100 nm. Preferably, the coating follows the rugged topography of the first and/or second area. In particular, the coating, in the region of the first and/or second area, has protrusions and/or recesses according to at least one embodiment as described above.

Exemplary embodiments of the invention are explained in the following with the aid of schematic drawings and reference numbers. Identical reference numbers designate elements or components with identical functions. Insofar as elements or components correspond to one another in function, the description of them will not be repeated in the description of each of the following figures.

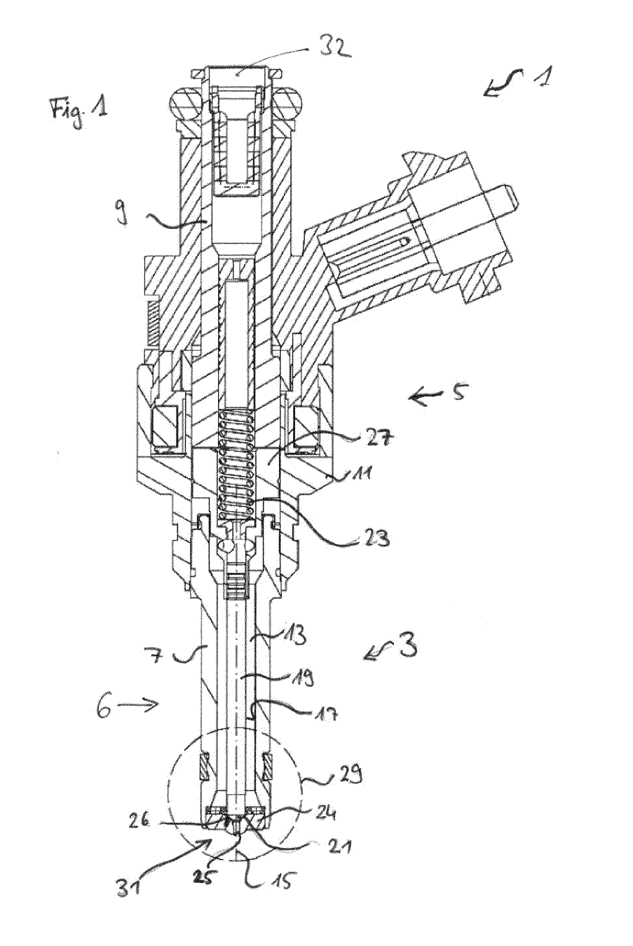

FIG. 1 shows an embodiment of an injection valve 1 with a nozzle assembly group 3 and an actuator 5. The actuator 5 functionally interacts with the nozzle assembly group 3.

The nozzle assembly group 3 comprises a valve body 6. The injection valve 1 further comprises an injector body 9. The valve body 6 is, for example, fixedly coupled to the injector body 9 by a nozzle cap nut 11. Alternative connections like press-fit and/or welded connections are conceivable as well for fixedly coupling the injector body 9 to the valve body 6. The valve body 6 and the injector body 9 form a common housing of the injection valve 1 for hydraulically connecting a fuel outlet end 31 of the injection valve 1 to a fuel inlet end 32 of the injection valve 1.

The valve body 6 has a base body 7 comprising a valve cavity 13 with a central longitudinal axis 15 and a wall 17. Within the valve cavity 13 a needle 19 is arranged, which is comprised by the nozzle assembly group 3. The needle 19 has a sealing element 21 at one end. The sealing element 21 may have a round end portion which in particular faces the fluid outlet end. The needle 19 is guided in an area of the valve cavity 13 in axially moveable fashion and is biased by a spring element 23 towards the fluid outlet end 31.

The valve body 6 further comprises a nozzle body 24, which limits a free volume of the valve cavity 13. The nozzle body 24 comprises one or several nozzle apertures 25, which are arranged next to the sealing element 21 of the needle 19. The nozzle body 24 comprises a valve seat 26. In a closed position, the sealing element 21 of the needle 19 sealingly rests on the valve seat 26 due to the spring force of the spring element 23. In the closed position, the sealing element 21 prevents fluid flow through the nozzle aperture(s) 25 in this way.

The injector body 9 has a recess, in which an actuator element 27 is arranged. The recess extends the valve cavity 13 towards the fuel inlet end 32. The actuator element 27 may be an armature of an electromagnetic-actuator. The actuator 5 actuates the needle 19 by means of mechanical interaction of the actuator element 27 with the needle 19 such that the needle 19 can perform a movement along a direction of the central longitudinal axis 15.

The spring element 23 exerts a force to the needle 19 to press the sealing element 21 against the valve seat 26, in order to prevent a flow of a fluid through one or several nozzle apertures 25 of the valve body 6. The exerted force acts in a direction of closing. By actuating the actuator 5, the needle 19 is moved in axial direction away from its closed position towards an open position. In this way fluid flow through one or several nozzle apertures 25 is enabled.

In some embodiments, the fluid is gasoline or diesel. The fluid can also be another substance, e.g., an organic compound like carbamide.

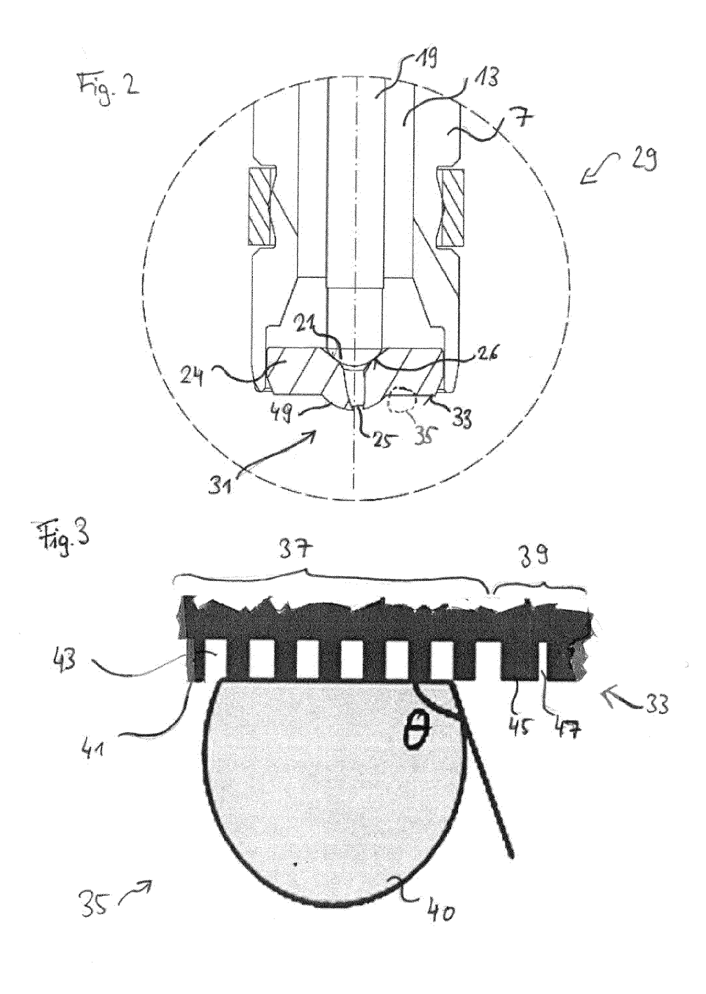

FIG. 2 shows an enlarged view of a section 29 of FIG. 1, which reveals the constructional design of the fuel outlet end 31 of the injection valve 1 in more detail. The fuel outlet end 31 in particular defines a portion of the injection valve 1 which comprises the nozzle body 24 and faces a combustion chamber.

The valve body 6 comprises the nozzle body 24, wherein the nozzle body 24 limits a free volume of the valve cavity 13. The nozzle body 24 is fixed to the base body 7 of the valve body 6. In this embodiment, the nozzle body 24 only comprises one nozzle aperture 25. Alternatively, the nozzle body 24 can comprise several nozzle apertures 25.

According to FIG. 2 (and to FIG. 1), the base body 7 and the nozzle body 24 are two pieces. Alternatively, the valve body 6 can be formed in one piece, comprising a first portion representing the nozzle body 24 and a second portion representing the base body 7. The nozzle body 24 is then integrally designed with the base body 7.

In case that the needle 19 enables a flow of fluid, fluid can pass through the one nozzle aperture 25 into a combustion chamber of the combustion engine. Such an injection process may cause the fluid to wet an outer surface 33 of the nozzle body 24. The outer surface 33 is facing away from the fluid inlet end 32 and from the cavity 13. It is positioned on the side of the nozzle body 24 opposite of the valve seat 26.

In a conventional injection valve, one or several droplets of the fluid may wet the surface 33 and may stick thereto. During several injection processes, several droplets can combine and accumulate. As described above, due to the high temperatures during a combustion process, the droplets or accumulated droplets can coke and thus coking deposits are generated and may be attached to the surface 33. Such coking deposits are responsible for emission performance degradation, as stated above.

In order to prevent droplets or fluid sticking to the surface 33, in case of the injection valve 1 according to the present embodiment, the outer surface 33 is modified and comprises a modified roughness.

FIG. 3 shows an exemplary section 35 (cf. FIG. 2) of the outer surface 33 with a droplet 40 on the outer surface 33. The elements illustrated in the figure and their size relationships among one another should not be regarded as true to scale. Rather, individual elements may be represented with an exaggerated size for the sake of better representability and/or for the sake of better understanding.

FIG. 3 shows the schematic sectional view of the outer surface of the nozzle body 24 in a plane comprising the central longitudinal axis 15. The outer surface 33 comprises a first area 37 and a second area 39. The first area 37 is designed to form a contact angle θ of more than 90° with a droplet 40 of the fluid to be injected by the injection valve 1, the fluid being in particular gasoline or diesel. The second area 39 is designed to form a contact angle θ of less than 90° with the droplet 40 of said fluid. Therefore, the outer surface 33 comprises a bimodal roughness.

The sticking force between the droplet 40 and the first area 37 is particularly small due to the fluid contact angle θ of more than 90°. Such a contact angle is achievable by means of the first area comprising several small projections 41 and several large recesses 43. The small projections 41 may, for example, be bumps, pins and/or small towers. In the shown embodiment, the small projections comprise dimensions, in particular lateral dimensions, in the nanometer range and are towers comprising a small width. For example, a maximum diameter, e.g. the outmost diameter, of the small projections 41 is between 30 nm and 100 nm.

The large recesses 43 can also be called large spacing. In particular, the small projections 41 are laterally spaced apart by comparatively large distances. The large recesses 43 or the lateral distance of adjacent small protrusions 41 may, for example, have dimensions in micrometer range. For example, a maximum diameter—e.g. the outmost diameter—of the large recesses 43 or the maximum lateral distance of directly adjacent protrusions 41 is between 300 nm and 600 nm. Such large recesses 43 and small projections 41 are suitable to form a contact angle θ between the first area 37 and the droplet 40, which is larger than 90°. Such a contact angle θ minimizes the sticking force between the droplet 40 and the surface 33. Thus, the droplet 40 can easily detach from the nozzle body 24. Any accumulation of droplets 40 during several injection processes can thus be avoided or at least largely reduced. Additionally, less or no coking deposits may be formed on the outer surface 33.

In order for the droplet 40 to detach from the first area 37 of the outer surface 33, an external stimulus may be necessary. Such an external stimulus can be vibrations of the engine or motion of air or combustion gas within the combustion chamber.

The second area 39 comprises large projections 45 and small recesses 47, in order to exhibit a contact angle θ with the droplet 40, which is smaller than 90°. The second area 39 comprises a weaker fluid-phobic surface than the first area 37. The large projections 45 may, for example, be bumps, pins and/or large towers. In the shown embodiment, the large projections 45 comprise dimensions in micrometer range and are towers, which comprise a large width. The large projections 45 may, for example, comprise dimensions in micrometer range, wherein a maximum diameter, e.g. the outmost diameter, of the large projection 43 is between 300 nm and 600 nm. The small recesses 47 can also be called small spacing.

In particular, the large projections 45 are laterally spaced apart by comparatively small distances. For example, a maximum diameter—e.g. the outmost diameter—of the small recesses 47 or the maximum lateral distance of directly adjacent protrusions 45 is between 30 nm and 100 nm. Such small recesses 47 and large projections 45 are suitable to form a contact angle θ between the second area 39 and the droplet 40, which is smaller than 90°. Such a contact angle θ forms a sticking force between a droplet 40 and the surface 33, which is larger than the sticking force of a droplet 40 stuck to the first area 37.

The second area 39 is adjacent to the first area 37. In particular, the first area 37 extends completely circumferentially around the nozzle aperture 25 and the second area 39 extends completely circumferentially around the first area 37. The second area 39 may be directly adjoining the first area 37. There may also be a transition region between the first and second areas 37, 39 (not shown in the figures). In the transition region, the protrusions may have lateral dimension between the respective lateral dimensions of the small protrusions 41 in the first area 37 and the large protrusions 45 in the second area 39. Additionally or alternatively, the lateral distance of adjacent protrusions may have a value between the respective distances in the first and second areas 37, 39.

Since droplets naturally move towards areas of weak fluidphobicity, the droplet 40 can move from the first area 37 to the second area 39 thereby reducing its potential energy, for example. If the droplet 40 does not detach from the first area 37, the droplet 40 may move to a second area 39 and may drag along coking deposits from former injection processes. Thus, any accumulation of coking deposits is avoided. In other words, a self-cleaning surface 33 is provided. The droplet 40 can, for example, be detached as soon as the engine is turned on. Alternatively, the droplet 40 can also detach due to vibrations of the engine or air motion within a combustion chamber.

According to the arrangement of region 35, the first area 37 is arranged closer to the nozzle aperture 25 than the second area 39. As described above, since the droplet 40 spontaneously moves towards areas of weaker fluidphobicity, a droplet 40, which does not detach from the surface 33, will not interfere with the spray of the fluid. This helps to achieve a minimized injector flow shift over the lifetime and a minimized variation of the spray angle.

The outer surface 33 in region 35 according to FIG. 3 is illustrated as a plane surface. However, region 35—in particular the first area 37—can also comprise a portion of a protrusion 49 of the nozzle body 24 through which the nozzle aperture 25 extends to the outer surface 33.

In a variant of the present embodiment (not shown in the figures), the outer surface 33 may comprise only a first area 37 and no fluid-philic second area 90. For example, the first area 37 is congruent with the whole outer surface 33. In another alternative not shown, the second area 39 can only be arranged on the left-most or right-most position of the outer surface 33 of the nozzle body 24, while the remaining outer surface 33 comprises the first area 37.

As described above, droplets naturally move towards areas of weaker fluidphobicity. Therefore, the second area 39 needs to form a contact angle θ with a fluid, which is larger than a contact angle θ with a fluid of the first area 37. Therefore, the second area 39 does not necessarily need the form a contact angle θ which is smaller than 90°. For example, the first area 37 can form a contact angle θ with a fluid—in particular gasoline—which is 120°. In order to achieve a droplet 40 moving from the first area 37 to the second area 39, the second area 39 can be designed to form a contact angle θ with said fluid, which is 100°, for example. In order to achieve droplets detaching 40 from the surface 33, the first area 37 should form a contact angle θ with a fluid, which is as large as possible. Thus, the sticking force between the droplet 40 and the first area 37 is very small.

Outer surface 33 described in FIGS. 2 and 3 comprises a bi-modal tuneable roughness in both micrometer and nanometer range. Such roughness can be advantageously achieved by laser scattering or plasma ionization.

In the embodiments shown, the nozzle body 24 comprises only one nozzle aperture 25. Alternatively, the nozzle body 24 can comprise several nozzle apertures 25, as stated above. It should be noted that the first area 37 of the surface 33 shall surround the nozzle apertures 25. The first area 37 shall be closer to the nozzle apertures 25 than the second area 39.

What is claimed is:

1. A fuel injection valve for a combustion engine, the injection valve comprising valve body comprising a valve cavity and a nozzle body; wherein:
the nozzle body limits the free volume of the valve cavity and comprises at least one nozzle aperture;
the nozzle body comprises a surface facing a combustion chamber of the combustion engine and at least partially surrounding the at least one nozzle aperture;
wherein the surface comprises a first area which completely laterally surrounds the nozzle aperture and which is fluid-phobic; and
the surface comprises a second area, adjacent to the first area which laterally surrounds the first area and has a weaker fluid-phobicity than the first area or is fluid-philic.

2. A fuel injection valve according to claim 1, in which the first area of the surface comprises small projections and large recesses.

3. A fuel injection valve according to claim 2, in which the small projections comprise dimensions in nanometer range.

4. A fuel injection valve according to claim 2, in which the large recesses comprise dimensions in micrometer range.

5. A fuel injection valve according to claim 2, in which a maximum diameter of the small projections is between 30 nm and 100 nm and which a maximum diameter of the large recesses is between 300 nm and 600 nm.

6. A fuel injection valve according to claim 1, in which the second area of the surface comprises small recesses and large projections.

7. A fuel injection valve according to claim 6, in which the small recesses comprise dimensions in nanometer range.

8. A fuel injection valve according to claim 6, in which the large projections comprise dimensions in micrometer range.

9. A fuel injection valve according to claim 6, in which a maximum diameter of the large projections is between 300 nm and 600 nm and a maximum diameter of the small recesses is between 30 nm and 100 nm.

10. A fuel injection valve according to claim 1, in which the surface of the injection nozzle is at least partially covered by at least one coating, in particular a fluid-phobic coating.

11. A combustion engine comprising:
an injection valve dosing fuel from a high pressure reservoir into a combustion chamber of the combustion engine;
the injection valve having a valve body with a valve cavity and a nozzle body;
wherein the nozzle body limits the free volume of the valve cavity and comprises at least one nozzle aperture;
the nozzle body comprises a surface facing a combustion chamber of the combustion engine and at least partially surrounding the at least one nozzle aperture;
wherein the surface comprises a first area which completely laterally surrounds the nozzle aperture and which is fluid-phobic; and
the surface comprises a second area, adjacent to the first area which laterally surrounds the first area and has a weaker fluid-phobicity than the first area or is fluid-philic.

12. A combustion engine according to claim 11, in which the first area of the surface comprises small projections and large recesses.

13. A combustion engine according to claim 12, in which the small projections comprise dimensions in nanometer range.

14. A combustion engine according to claim 12, in which the large recesses comprise dimensions in micrometer range.

15. A combustion engine according to claim 12, in which a maximum diameter of the small projections is between 30 nm and 100 nm and which a maximum diameter of the large recesses is between 300 nm and 600 nm.

16. A combustion engine according to claim 11, in which the second area of the surface comprises small recesses and large projections.

17. A combustion engine according to claim 16, in which the small recesses comprise dimensions in nanometer range.

18. A combustion engine according to claim 16, in which the large projections comprise dimensions in micrometer range.

19. A combustion engine according to claim 16, in which a maximum diameter of the large projections is between 300 nm and 600 nm and a maximum diameter of the small recesses is between 30 nm and 100 nm.

20. A combustion engine according to claim 11, in which the surface of the injection nozzle is at least partially covered by at least one coating, in particular a fluid-phobic coating.
